(19) United States
(12) Patent Application Publication
(10) Pub. No.: US 2011/0215565 A1
(43) Pub. Date: Sep. 8, 2011

(54) COUPLING ELEMENT FOR CONNECTING TWO PIPE ENDS

(75) Inventors: Andreas BAUER, Maintal (DE); Jerôme CHATEAU, Metz (FR)

(73) Assignee: NORMA GERMANY GMBH, Maintal (DE)

(21) Appl. No.: 13/036,830

(22) Filed: Feb. 28, 2011

(30) Foreign Application Priority Data
Mar. 6, 2010 (DE) 10 2010 010 463.9
Apr. 16, 2010 (DE) 102010015157.2-24

(51) Int. Cl. F16L 35/00

(52) U.S. Cl. 285/129.1

(57) ABSTRACT

Coupling element for connecting two pipe ends. The coupling element includes a housing with a first connecting end, a second connecting end, and a connecting channel formed between the first and second connecting ends, and a vent duct having a passage covered by a hygroscopic seal and a vent valve that includes a valve seat and a valve element arranged in series with the hygroscopic seal and the passage. The valve element is structured to be lifted from the valve seat by a pressure in the connecting channel.

### CROSS-REFERENCE TO RELATED APPLICATIONS

The present application claims priority under 35 U.S.C. §119 of German Patent Application No. 10 2010 010 463.9 filed Mar. 6, 2010 and German Patent Application No. 10 2010 015 157.2-24 filed Apr. 16, 2010, the disclosures of which is expressly incorporated by reference herein in their entireties.

### BACKGROUND OF THE INVENTION

1. Field of the Invention

The invention relates to a coupling element for connecting two pipe ends, in particular, of a coolant circuit of a motor vehicle, with a housing that has a first connecting end and a second connecting end, between which a connecting channel is embodied or formed, and a vent duct.

2. Discussion of Background Information

Coupling elements of this type are used in the production of line systems to connect individual pipe ends to one another, but also, for example, to form branches or, for example, to introduce control elements, such as valves or closable openings, into the system. Pipe ends thereby mean not only the ends of rigid pipes, but ends of any kind of lines and, for example, also pipe connections.

Line systems, such as, for example, a coolant circuit of a motor vehicle, are often filled with a liquid. A venting of the system is generally necessary. In a coolant circuit of a motor vehicle, the venting is carried out, for example, by the removal of a cover cap from a vent duct, which is closed again only when cooling water emerges from the vent duct. A vacuum-tight seal of the vent duct can thereby be carried out by the use of the cover cap, which is necessary in particular during a filling operation in which a liquid is suctioned.

However, the use of a cover cap requires action by an operator.

### SUMMARY OF THE INVENTION

Embodiments of the invention provide a coupling element that renders possible a fully automatic and vacuum-tight venting.

According to the embodiments, an outlet opening of the vent duct is covered by a hygroscopic seal. In the vent duct, a vent valve with a valve seat and a valve element is arranged, which can be lifted from the valve seat by a pressure in the connecting channel.

In this application, “passage” can refer to an opening of the vent duct outside the connecting channel, e.g., into the surroundings. It can thereby be ensured by the use of a hygroscopic seal that the liquid cannot leak out, although a venting can take place. A hygroscopic seal is able to absorb moisture and to release it again if necessary. However, the hygroscopic seal alone does not render possible a vacuum-tight closure of the vent duct. Further, “vacuum-tight” can refer to a seal that permits a buildup of underpressure in the connecting channel, i.e., a seal that has a sufficient tightness. This tightness is ensured by the vent valve, wherein a very tight closure by the bearing of the valve element on the valve seat is ensured because the valve element can be lifted from the valve seat by a pressure in the connecting channel or can be suctioned against the valve seat by an underpressure. The buildup of underpressure in the connecting channel is therefore possible, while a venting is ensured by lifting the valve seat and escaping through the hygroscopic seal. It is not necessary for an operator to take action for this purpose. Through the arrangement of the vent valve with the hygroscopic seal in series, that is, one behind the other, everything wanting to escape from the connecting channel through the vent duct must pass through the vent valve as well as the hygroscopic seal.

It is particularly preferred thereby that the valve element is loaded by a force in the closure direction. For example, the valve element is loaded with a spring force. The vent valve is therefore thereby held in a normally closed position. The valve element can be drawn downwards against the valve seat by the force of gravity, for example. The use of a spring that loads the valve element in the closed direction means that the forces necessary for opening the vent valve, that is, in particular a necessary overpressure in the connecting channel, can thereby be adjusted relatively precisely. At the same time, the certainty that the valve element will bear against the valve seat is increased due to the spring, which is advantageous, for example, with applications that are subject to vibrations.

Preferably, the hygroscopic seal is arranged in a hollow cylindrical insert, which is arranged in a pipe connection of the housing. It is thereby not necessary to produce the housing with a high degree of precision. It is sufficient that the hygroscopic seal is accommodated in the insert relatively precisely. The insert can then be pressed, screwed or welded into the housing, for example. In another embodiment, the insert is slidably arranged in the housing. An additional seal can be provided to seal between the insert and the housing, which additional seal is arranged, for example, on a front face of the insert and is arranged between the front face and the housing when the insert is inserted. The seal can also be a radial seal. By welding the insert into the coupling housing, the additional seal can be omitted.

It is particularly preferred thereby that a front face of the insert is closed by a cap. The hollow cylindrical insert is thus closed by the cap on its side facing away from the housing. This ensures that a venting is carried out only through the passage. However, an installation of the hygroscopic seal is easily possible before the cap is put on, wherein the insert can have an inwardly projecting flange on the end with which it is inserted into the housing, against which flange the hygroscopic seal bears. The insert with the seal and the cap then represent a compact unit that is easy to handle.

Preferably, the passage is arranged in a circumferential wall of the insert. The venting is thus not carried out simply in a straight direction, but a change of direction by about 90° is necessary. This makes it difficult for liquid to pass through.

Preferably, the hygroscopic seal has several sealing rings. The use of several sealing rings makes it possible to adapt the dimensions of the hygroscopic seal relatively precisely to the interior of the hollow cylindrical insert. An extension of the vent duct thereby occurs through a free cross section of the sealing rings.

Preferably, the vent duct has an orifice region in the connecting channel. This orifice region can thereby be embodied in the form of a restriction point, for example, that is, it can have a reduced inside diameter compared to the adjoining vent duct. The opening to the connecting channel can thereby be kept relatively small, which prevents an excessive exit of liquid. For venting only a relatively small opening is necessary.

Preferably, the valve element has an extension, which extends through the orifice region, wherein, if necessary, a length of the extension is longer than a travel distance of the valve element. The valve element is also guided in the orifice region by the extension. The extension thereby closes a large part of the cross section of the orifice region, so that in all only a relatively small open cross section and thus a small opening of the connecting channel is maintained. Liquid can therefore leak out only in relatively small quantities, which can be easily trapped by the hygroscopic seal.

Preferably, the vent duct has a guide region, wherein the orifice region has a smaller diameter than the guide region and the valve seat is formed by a step between the guide region and the orifice region. The guide region can then have a sufficiently large diameter, so that e.g., a movement of the valve element in the guide region is easily possible. The weakening of the housing and in particular an opening to the connecting channel is kept low by a reduction of the diameter in the orifice region. This is advantageous with respect to obtaining a good seal. The valve seat can be integrated into the housing without great expenditure as a result of the embodiment of the valve seat by the step between the guide region and the orifice region. The step is thereby produced by the reduction in diameter in the orifice region compared to the diameter of the guide region.

Advantageously, the valve element is guided in the guide region. The valve element can thus simply be placed in the guide region of the vent duct, such that it is guided during a movement through the guide region. For example, the valve element is radially supported on circumferential walls in the guide region. It can thereby be ensured by corresponding irregularities of the valve element that venting is possible between the valve element and the circumferential sides of the guide region. It is also conceivable to produce the valve element with such a large clearance that there is always a sufficient air gap between the valve element and circumferential sides of the guide region.

Preferably, the valve seat is embodied or formed in a funnel-shaped manner, and the valve element in particular has a conical bearing surface. A flat contact surface is therefore obtained between the valve seat and the valve element when the valve element bears against the valve seat. This has an advantageous effect on an achievable tightness. The achievable tightness can be further increased by producing the valve element and/or the housing from a relatively soft or elastic material so that an elastic deformation occurs when the valve element bears against the valve seat.

Preferably, a second front face of the insert forms a stop for the valve element. The travel distance of the valve element in the opening direction is therefore limited by the insert. It is thereby possible to embody the vent duct in a relatively simple manner. At the same time, the travel distance is defined by the insert and a loss of the valve element is prevented.

Preferably, the connecting ends are arranged at an angle of greater than 0° to one another, in particular at a 90° angle. This makes an assembly of the coupling element possible such that the vent valve is arranged at the highest point.

One of the connecting ends can thereby be embodied or formed as an insert part and the other of the connecting ends can be embodied or formed as a receiving part. This makes a relatively simple connection of the coupling element to the pipe ends possible.

Preferably, the vent duct runs in a direction parallel to one of the connecting ends. The insertion of the vent duct and the insert is then possible in a relatively simple manner in that the connecting end is fixed. The forces necessary during insertion are then directly transferred into the connecting end running parallel.

It is preferred thereby that the vent duct is offset with respect to the connecting end. This ensures that the vent element, even if the ram projects through the vent duct into the connecting channel, is not flowed against by the main flow of a liquid in the connecting channel, which could lead to an undesirable opening of the vent valve. Through the offset arrangement of the vent duct, the security is also improved.

Preferably, the cap forms the valve element. The number of individual elements is thus reduced. An opening or closing of the vent valve then takes place by a movement of the cap with respect to the pipe connection of the housing. It is therefore already easy to recognize from outside whether the vent valve is open or closed. In this embodiment, the valve seat, which with the valve element or with the cap forms the vent valve, is arranged behind the hygroscopic seal and the passage in the direction of flow. Fluid flowing out of the connecting channel through the vent duct must therefore first pass through the hygroscopic seal and then the vent duct. It is particularly preferred thereby that the insert is connected to the cap and is arranged in a linearly moveable manner in the housing. A radial seal is arranged in particular between the insert and the housing. The passage can then be embodied or formed in the connecting point between the insert and the housing, for example. A guide of the cap or of the valve element thereby takes place through the insert. The radial seal between the insert and the housing ensures that even with a movement between the insert and the housing, no fluid can bypass the hygroscopic seal.

Preferably, the cap is embodied in a cup-shaped manner with a base and a full perimeter wall, wherein an annular seal is arranged in particular between an outer wall of the pipe connection and an inside of the wall. The full perimeter wall of the cap thereby surrounds the pipe connection of the housing in which the insert is guided. The passage is thereby likewise protected by the wall from environmental effects. At the same time, a guiding of the cap through the interaction of the wall with the outside wall of the pipe connection can take place.

Preferably, the annular seal bears against either the inside or the outer wall in an open position of the valve element and bears against the inside as well as against the outside wall in a closed position. In the open position of the valve element, the annular seal is thus without a sealing function, while an additional seal takes place in the closed position of the valve element. A vacuum-tight closure is thus ensured in the closed position.

Preferably, slots are embodied in the wall, which optionally in the closed position are sealed by the annular seal. In the open position, however, the slots are not sealed by the annular seal. A controlled escape of air from the vent duct can take place through the slots. At the same time, a vacuum tight closure is possible by the annular seal.

Embodiments of the invention are directed to a coupling element for connecting two pipe ends. The coupling element includes a housing with a first connecting end, a second connecting end, and a connecting channel formed between the first and second connecting ends, and a vent duct having a passage covered by a hygroscopic seal and a vent valve that includes a valve seat and a valve element arranged in series with the hygroscopic seal and the passage. The valve element is structured to be lifted from the valve seat by a pressure in the connecting channel.

According to aspects of the embodiments, the coupling element can be structured and arranged in a coolant circuit of a motor vehicle.

In accordance with other aspects, the valve element may be loadable by a force in a closure direction.

According to further aspects of the embodiments, a hollow cylindrical insert can be arranged at least in part in a pipe connector stub of the housing. The hygroscopic seal can be arranged in the hollow cylindrical insert. Further, a cap may be arranged to close a first front face of insert. A passage can be is formed in a circumferential wall of the insert.

In accordance with still other aspects of the embodiments, the hygroscopic seal comprises several sealing rings.

Moreover, the vent duct may include an orifice region coupled to the connecting channel. The valve element can include an extension that is arranged to extend through the orifice region. The length of the extension may be longer than a travel distance of the valve element. Further, the vent duct can also include a guide region, such that the orifice region has a smaller diameter than the guide region and the valve seat is formed by a step between the guide region and the orifice region. The valve element can be guided in the guide region.

According to other aspects, the valve seat can include a funnel-shaped portion and the valve element comprises a conical bearing surface.

In accordance with still yet other embodiments of the present invention, the insert may have a second front face arranged as a stop for the valve element. The cap can form the valve element. The insert can be connected to the cap and may be arranged in a linearly moveable manner in the housing. Further, a radial seal can be arranged between the insert and the housing. Moreover, the cap can have a cup-shape with a base and a full perimeter wall, and the coupling element may further include an annular seal arranged between an outer wall of a pipe connector stub of the housing and an inside of the full perimeter wall. Still further, when in an open position of the valve element, the annular seal can be arranged to bear against one of the outer wall of the pipe connector stub or the inside of the full perimeter wall an inside and, when in a closed position of the valve element, the annular seal can be arranged to bear against an outside of the full perimeter all wall in an open position of the valve element and bears against the outer wall of the pipe connector stub or the inside of the full perimeter wall an inside. The coupling element can also include slots formed in the full perimeter wall that are sealable by the annular seal when the valve element is in the closed position.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a cross section through a coupling element with a vent valve in a first embodiment,

FIG. 2 illustrates a cross section through a coupling element of a second embodiment with a vent valve in the closed position,

FIG. 3 illustrates a The coupling element according to FIG. 2 in a three-dimensional representation,

FIG. 4 illustrates a The coupling element according to FIG. 2 in the open position and

FIG. 5 illustrates a The coupling valve according to FIG. 4 in a three-dimensional representation.

### DETAILED DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

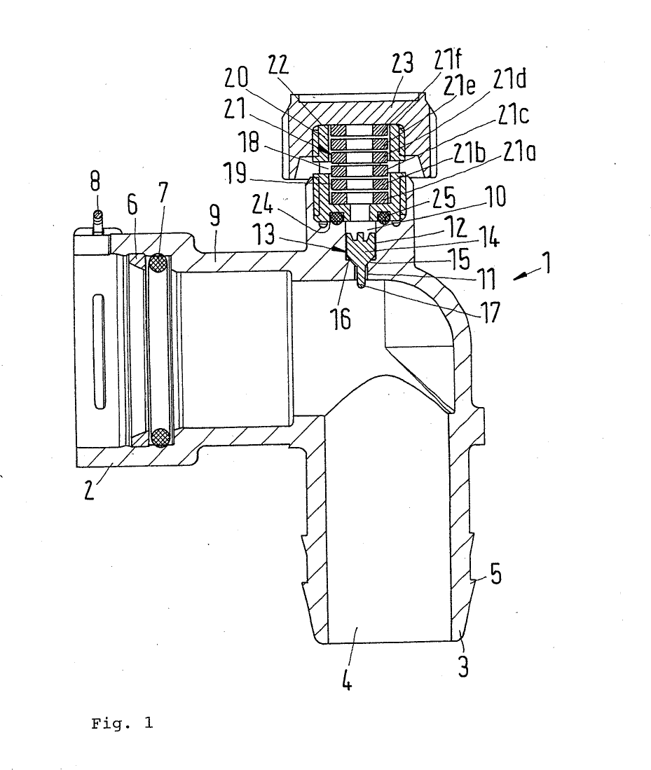

FIG. 1 illustrates in cross section a coupling element 1, which has a first connecting end 2, a second connecting end 3, and a connecting channel 4 embodied or formed there between. Liquids can therefore be guided through coupling element 1 or through connecting channel 4. Connecting end 2 is embodied or formed as an insert end so that a pipe end can be inserted therein. Connecting end 3 is embodied or formed as an insert end that can be inserted into a pipe end embodied or formed as, for example, a hose.

For the secure connection with a pipe end, connecting end 3 is provided with a sawtooth structure 5 on its outside. Connecting end 2 is provided on its inside with a spring ring 6 and a sealing ring 7. On its outside, connecting end 2 has a latch 8. These elements are used in a known manner to produce a tight connection of a pipe end in coupling element 1.

Connecting ends 2 and 3 can be arranged at a 90° angle to one another, as illustrated in the exemplary embodiment. However, other arrangements are also conceivable. By way of non-limiting example, connecting ends 2 and 3 can also be aligned parallel to one another, such that these ends are aligned axially to one another.

A vent duct 10 is provided in housing 9 of coupling element 1. Vent duct 10 opens into connecting channel 4, and establishes a connection of connecting channel 4 to the surroundings. Vent duct 10 has an orifice region 11 and a guide region 12. Orifice region 11 is adjacent to connecting channel 4 and has a smaller diameter than guide region 12.

A vent valve 13 is arranged in vent duct 10. Vent valve 13 has a valve element 14 and a valve seat 15. In the exemplary embodiment, valve seat 15 is thereby formed by a step, which is produced by a reduction in diameter of orifice region 11 with respect to guide region 12. Valve element 14 is loaded in the closing direction by the force of gravity in this exemplary embodiment. Valve element 14 is thereby guided in guide region 12 of vent duct 10, such that it can be radially supported and can be axially moveable with respect to vent duct 10.

Valve element 14 has an extension 17, which extends through orifice region 11 into connecting channel 4.

Valve seat 15 is embodied or formed in a funnel-shaped manner. Valve element 14 has a corresponding bearing surface so that an area contact is obtained when valve element 14 bears against valve seat 15. A very high tightness is thus achieved in particular with different materials of valve element and housing, wherein in particular one of the two materials should be softer.

A passage 18 of vent duct 10 is embodied or formed in a circumferential wall 19 of a hollow cylindrical insert 20 that is screwed into a pipe connection of housing 9 so that vent duct 10 runs through insert 20. A hygroscopic seal 21, which is arranged in the interior of insert 20, covers passage 18. Hygroscopic seal 21 is thereby formed by several sealing rings 21a-21f. Central circular openings of sealing rings 21a-21f are thereby used to extend vent duct 10. Vent valve 13 is arranged in front of passage 18 and hygroscopic seal 21 in the direction of flow.

A first front face 22 of insert 20 is closed with a cap 23 in a fluid-tight manner. Cap 23 is thereby screwed onto insert 20 or welded to insert 20. Cap 23 is embodied or formed in a cup-shaped manner and covers passage 18 with a full perimeter wall, such that a contamination of passage 18 from outside is prevented.

A sealing ring 25, which seals the connection between insert 20 and housing 9 in an axial direction, is arranged on a second front face 24 of insert 20 that is inserted into housing 9.

Housing 9 can be made of plastic or metal. Insert 20 and valve element 14 can likewise be made of metal or a plastic. Hygroscopic seal 21 can contain, e.g., cellulose.

With the application of an underpressure or a vacuum in connecting channel 4, valve element 14 is suctioned and bears in a sealing manner against valve seat 15, so that a tight closure of vent duct 10 is obtained. Valve element 14 can be lifted from valve seat 15 by a slight overpressure, so that enclosed air can escape through vent duct 10 and passage 18. Hygroscopic seal 21 represents only a relatively slight obstacle thereby. However, hygroscopic seal 21 is a strong obstacle to possibly any liquid exiting with it thereby. Since only a relatively small free cross section is available through the small air gap between the valve element and the guide region or the extension in the orifice region, liquid can also reach seal 21 only in small quantities, which can be easily absorbed by hygroscopic seal 21. Liquid is thus successfully prevented from escaping by the coupling element, while an automatic venting is ensured. At the same time a vacuum-tight closure of the vent duct is ensured.

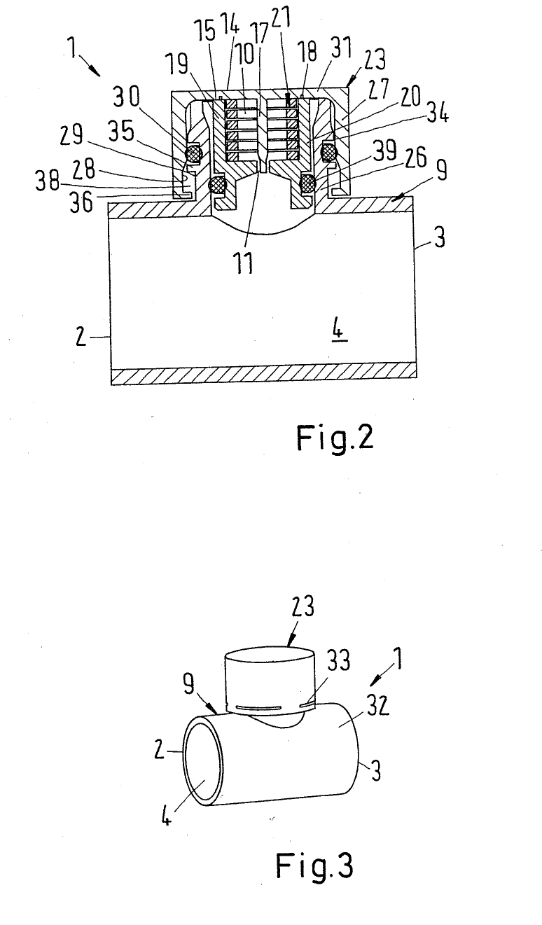

FIG. 2 shows coupling valve 1 in a further preferred embodiment. Insert 20 is thereby moveably guided in pipe connection 26 of housing 9. Valve element 14 and cap 23 are thereby embodied or formed as a single component. A first front face of pipe connection 26 forms valve seat 15. Vent valve 13 with valve element 14 and valve seat 15 is therefore arranged in series behind hygroscopic seal 21 and passage 18. An annular seal 30 is arranged between an inside 28 of the full perimeter wall 27 of cup-shaped cap 23 and an outside wall 29 of pipe connection 26. In the closed position shown, annular seal 30 bears against inside 28 as well as outside wall 29 and thus seals between pipe connection 26 and cap 23.

Passage 18 is embodied or formed at a joint between front face 22 of insert 20 and a base 31 of cap 23. For example, a connection that is not fluid-tight is provided for this purpose between insert 20 and cap 23.

FIG. 3 shows coupling element 1 in a three-dimensional view, in which vent valve 13 is in the closed position. Cap 23 or its wall 27 then almost rests on an outer casing 32 of connecting channel 4 or housing 9. It is therefore easily discernible to see that the vent valve is in the closed position.

Slots 33 are embodied or formed in wall 27. Through these slots 23, a venting of vent duct 10 can be carried out.

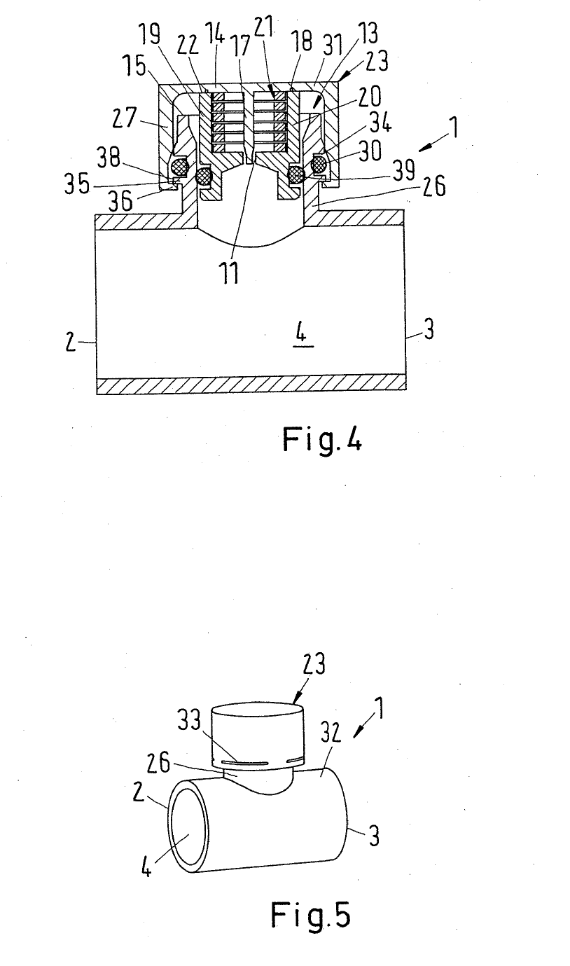

In FIG. 4, coupling element 1 of the embodiment according to FIG. 3 is shown in the open position. Cap 23 and insert 20, in which hygroscopic seal 21 is arranged, have been moved out of housing 9 or the pipe connection 26 in a linear manner, so that a passage cross section has been released between base 31 of cap 23, which forms valve element 14, and valve seat 15. Air that reaches through hygroscopic seal 21 and passage 18 can thus escape outwards into the surroundings through the gap between valve element 14 and valve seat 15 and slots 33. Annular seal 30 is not an obstacle, since it bears only against outer wall 29 of pipe connection 26. A movement of annular seal 30 due to the movement of cap 23 is prevented because annular seal 30 is accommodated in an annular groove 34.

To limit the linear movement between cap 23 and housing 9, a stop 35 is embodied or formed in pipe connection 26, which interacts with corresponding hooks 36 of wall 27.

Slots 33 are arranged in the region of a recess 38 of inside 28 so that they are accessible in an open position, such that they are covered by annular seal 30 in the closed position.

FIG. 5 now shows coupling element 1 in the open position. Cap 23 is clearly spaced apart from outer casing 32. Thus, from outside it is easily discernible that the connecting channel 4 is not yet completely vented.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A coupling element for connecting two pipe ends, comprising:
a housing with a first connecting end, a second connecting end, and a connecting channel formed between the first and second connecting ends;
a vent duct having a passage covered by a hygroscopic seal and a vent valve that includes a valve seat and a valve element arranged in series with the hygroscopic seal and the passage,
wherein the valve element is structured to be lifted from the valve seat by a pressure in the connecting channel.

2. The coupling element in accordance with claim 1, wherein the coupling element is structured and arranged in a coolant circuit of a motor vehicle.

3. The coupling element in accordance with claim 1, wherein the valve element is loadable by a force in a closure direction.

4. The coupling element in accordance with claim 1, further comprising a hollow cylindrical insert arranged at least in part in a pipe connection of the housing, wherein the hygroscopic seal is arranged in the hollow cylindrical insert.

5. The coupling element in accordance with claim 4, further comprising a cap arranged to close a first front face of insert.

6. The coupling element in accordance with claim 4, wherein a passage is formed in a circumferential wall of the insert.

7. The coupling element in accordance with claim 1, wherein the hygroscopic seal comprises several sealing rings.

8. The coupling element in accordance with claim 1, wherein the vent duct comprises an orifice region coupled to the connecting channel.

9. The coupling element in accordance with claim 8, wherein the valve element includes an extension that is arranged to extend through the orifice region.

10. The coupling element in accordance with claim 9, wherein a length of the extension is longer than a travel distance of the valve element.

11. The coupling element in accordance with claim 8, wherein the vent duct further comprises a guide region, and wherein the orifice region has a smaller diameter than the guide region and the valve seat is formed by a step between the guide region and the orifice region.

12. The coupling element in accordance with claim 9, wherein the valve element is guided in the guide region.

13. The coupling element in accordance with claim 1, wherein the valve seat comprises a funnel-shaped portion and the valve element comprises a conical bearing surface.

14. The coupling element in accordance with claim 5, wherein the insert has a second front face arranged as a stop for the valve element.

15. The coupling element in accordance with claim 14, wherein the cap forms the valve element.

16. The coupling element in accordance with claim 15, wherein the insert is connected to the cap and is arranged in a linearly moveable manner in the housing.

17. The coupling element in accordance with claim 16, wherein a radial seal is arranged between the insert and the housing.

18. The coupling element in accordance with claim 15, wherein the cap has a cup-shape with a base and a full perimeter wall, and the coupling element further comprises an annular seal arranged between an outer wall of a pipe connection of the housing and an inside of the full perimeter wall.

19. The coupling element in accordance with claim 18, wherein, when in an open position of the valve element, the annular seal is arranged to bear against one of the outer wall of the pipe connection or the inside of the full perimeter wall an inside and, when in a closed position of the valve element, the annular seal is arranged to bear against an outside of the full perimeter all wall in an open position of the valve element and bears against the outer wall of the pipe connection or the inside of the full perimeter wall an inside.

20. The coupling element in accordance with claim 18, further comprising slots formed in the full perimeter wall that are sealable by the annular seal when the valve element is in the closed position.
